(19) United States
(12) Patent Application Publication
(10) Pub. No.: US 2008/0286195 A1
(43) Pub. Date: Nov. 20, 2008

(54) Hydrogen generation systems and methods

(76) Inventor: Qinglin Zhang, Manalpan, NJ (US)

Correspondence Address: DICKSTEIN SHAPIRO LLP, 1825 EYE STREET NW, Washington, DC, 20006-5403, US

(21) Appl. No.: 11/798,458

(22) Filed: May 14, 2007

(51) Int. Cl. C01B 3/04; B01J 8/04

(52) U.S. Cl. 423/648.1; 422/116; 422/189

(57) ABSTRACT

Systems and methods for hydrogen generation that convert a boron hydride fuel to hydrogen by contacting the fuel with an acidic reagent, i.e., a reagent having a pH less than about 7, in the presence of water, are provided. The fuel may comprise a boron hydride in solid or slurry form, either utilized individually or as a mixture of two of more boron hydrides. The acidic reagent may comprise inorganic acids such as hydrochloric acid, sulfuric acid, and phosphoric acid, and organic acids such as acetic acid, formic acid, maleic acid, malic acid, citric acid, and tartaric acid, or mixtures thereof, and at least one additive.

### FIELD OF THE INVENTION

The present invention relates to systems and methods for hydrogen generation and, in particular, to the generation of hydrogen from a boron hydride fuel using an acidic reagent.

### BACKGROUND OF THE INVENTION

Hydrogen is the fuel of choice for fuel cells; however, its widespread use is complicated by the difficulties in storing the gas. Various nongaseous hydrogen carriers, including hydrocarbons, metal hydrides, and chemical hydrides are being considered as hydrogen storage and supply systems. In each case, systems need to be developed to release the hydrogen from its carrier, either by reformation as in the case of hydrocarbons, desorption from metal hydrides, or catalyzed hydrolysis of chemical hydrides.

### SUMMARY OF THE INVENTION

The present invention provides systems and methods for hydrogen generation by the acid catalyzed hydrolysis of a boron hydride fuel. In a preferred embodiment, the system includes a fuel chamber for containing a solid boron hydride fuel, a second chamber adapted to contain at least one acidic reagent capable of generating hydrogen upon contact with the solid fuel in the presence of water, and means for contacting the solid fuel with the acidic reagent to produce hydrogen gas and a product. The system may further include a hydrogen outlet line in communication with the boron hydride fuel chamber, a hydrogen separator adapted to prevent solids and liquids in the boron hydride fuel chamber from entering the hydrogen outlet line, and a liquid distributor comprising a plurality of ports configured to deliver the acidic reagent to the boron hydride fuel.

The present invention further provides methods of generating hydrogen gas by a hydrolysis reaction, utilizing a boron hydride fuel capable of generating hydrogen and a product when contacted with an acidic reagent in the presence of water. In an exemplary embodiment, a method according to the present invention comprises: (i) providing an acidic reagent comprising at least one additive; and (ii) contacting the acidic reagent with a boron hydride fuel in a chamber to generate hydrogen gas. The at least one additive may comprise, for example, an additive to reduce or eliminate foaming and may be selected from, for example, ethers of diols, amines, amino alcohols, amides, and fused ring heteroaromatics.

### BRIEF DESCRIPTION OF THE DRAWINGS

FIG. 1 is a schematic view of a hydrogen generation system in accordance with the present invention; and

FIGS. 2A and 2B are schematic views of two embodiments of a multi-channel liquid distributor in accordance with the present invention.

### DETAILED DESCRIPTION OF THE INVENTION

The present invention relates to systems and methods for hydrogen generation that convert a boron hydride fuel to hydrogen by contacting the fuel with an acidic reagent (for example, an aqueous acidic reagent), i.e., a reagent having a pH less than about 7. It is preferred that such hydrogen generation reactions proceed with high conversion of the boron hydride fuel to fully utilize all stored fuel components and ensure high energy density. In exemplary embodiments of the present invention, the fuel may comprise a boron hydride in solid form, either utilized individually or as a mixture of two of more boron hydrides. In certain embodiments of the present invention, the acidic reagent is an aqueous solution and may further comprise an additive.

The terms “boron hydride” or “boron hydrides” as used herein include boranes, polyhedral boranes, and anions of borohydrides or polyhedral boranes, such as those disclosed in co-pending U.S. patent application Ser. No. 10/741,199, entitled “Fuel Blends for Hydrogen Generators,” filed Dec. 19, 2003, the entire disclosure of which is hereby incorporated herein. Suitable boron hydrides include, without intended limitation, the group of borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, among others, where M is a cation selected from the group consisting of alkali metal cations, alkaline earth metal cations, aluminum cation, zinc cation, and ammonium cation, and n is equal to the charge of the cation; neutral borane compounds, such as decaborane(14) (B₁₀H₁₄); and ammonia borane compounds of formula NHₓBH_{y}, wherein x and y independently=1 to 4 and do not have to be the same, NHₓRBH_{y}, wherein x and y independently=1 to 4 and do not have to be the same, and R is a methyl or ethyl group, and formula NH₃B₃H₇. For the above-mentioned boron hydrides, M is preferably sodium, potassium, lithium, or calcium. These metal hydrides may be utilized in mixtures, but are preferably utilized individually.

A metal borohydride fuel component may be combined with a solid stabilizer agent selected from the group consisting of metal hydroxides, anhydrous metal metaborates, and hydrated metal metaborates, and mixtures thereof. Solid stabilized fuel compositions comprising about 20 to about 99.7 wt-% borohydride and about 0.3 to about 80 wt-% hydroxide salts are disclosed in co-pending U.S. patent application Ser. No. 11/068,838, entitled “Borohydride Fuel Composition and Methods,” filed on Mar. 1, 2005, the disclosure of which is incorporated by reference herein in its entirety.

The boron hydride fuels are preferably in solid, slurry, or solution form, and may be anhydrous or hydrated, preferably comprising from about 0 to about 80 wt-% water. As used herein, a “slurry” is a flowable mixture of particles suspended in a liquid. In some embodiments, the boron hydrides comprise water in amounts from about 20 to about 60 wt-%, and preferably from about 40 to about 60 wt-%. In certain embodiments, higher hydrated fuels comprising borohydride salts comprising water in amounts from about 50 to about 60 wt-% are preferred. As used herein, “higher hydrated fuels” means compositions that comprise water in greater amounts than found in the typical hydrated forms of borohydride salts; as used herein, “typical hydrated forms” include sodium borohydride dihydrate (NaBH₄.2 H₂O, 51.2 wt-% NaBH₄ and 48.8 wt-% water), potassium borohydride trihydrate (KBH₄.3 H₂O, 49.9 wt-% KBH₄ and 50.1 wt-% water), and potassium borohydride monohydrate (KBH₄.H₂O, 75 wt-% KBH₄ and 25 wt-% water).

Higher hydrated fuels may be prepared, for example, as disclosed in co-pending U.S. patent application Ser. No. 11/068,838, entitled “Borohydride Fuel Composition and Methods,” the disclosure of which is incorporated by reference in its entirety herein, by providing a metal hydroxide solution such as sodium hydroxide in water, and then adding a boron hydride, such as sodium borohydride, to the hydroxide solution to obtain a uniform slurry or solid composition.

Suitable acidic reagents include, but are not limited to, both inorganic acids such as hydrochloric acid (HCl), sulfuric acid (H₂SO₄), and phosphoric acid (H₃PO₄), and organic acids such as acetic acid (CH₃COOH), formic acid (HCOOH), maleic acid, malic acid, citric acid, and tartaric acid, among others. Preferably, the acidic reagent is a solution containing at least one acid in a concentration of between about 1 to about 60 wt-%, and preferably between about 20 to about 40 wt-%. For acidic reagents comprising mixtures of two or more acids, the combination of the acids may be present in a concentration of between about 1 to about 60 wt-%, and preferably between about 20 to about 40 wt-%, wherein the individual acids are combined in any ratio. For illustrative purposes, mixtures comprising about 15 wt-% citric acid and about 25 wt-% acetic acid, or about 35 wt-% HCl and about 5 wt-% citric acid, both have a total “acid” concentration of about 40 wt-%.

The acidic reagent may further comprise at least one additive in a concentration of between about 0.1 to about 10 wt-%, and preferably between about 0.2 to about 3 wt-%. Additives suited for use in the embodiments of the present invention include, for example, alcohols, diols, ethers of diols, amines, amino alcohols, amides, and fused ring heteroaromatics. Suitable examples of additives for use in embodiments of the present invention include, but are not limited to, methanol, ethanol, ethylene glycol, propylene glycol, 1,2-dimethoxyethane (glyme), diethylene glycol dimethyl ether (diglyme), triethylene glycol dimethyl ether (triglyme), tetraethylene glycol dimethyl ether (tetraglyme), dimethylacetamide, tetrahydrofuryl alcohol, ethylene diamine, and 2-aminoethanol, pyranthrenedione, indanthrene pigments, violanthrone pigments, 3,4,9,10-perylenetetracarboxylic diimide pigments, quinacridone pigments, 1,4-diketopyrrolo[3,4-c]pyrrole pigments, copper phthalocyanine, and indigo dye (also known as indigotin). The pigments described herein can be variably substituted; some suitable examples of indanthrene pigments, violanthrone pigments, 3,4,9,10-perylenetetracarboxylic diimide pigments, and quinacridone pigments include, but are not limited to, indanthrene gold orange, indanthrene black, indanthrene yellow; dimethoxy violanthrone, isoviolanthrone; ditridecyl-3,4,9,10-perylenetetracarboxylic diimide 3,4,9,10-perylenetetracarboxylic dianhydride, perylenetetracarboxylic diimide, N,N′-diphenyl-3,4,9,10-pery-lenetetracarboxylic acid diimide, N,N′-dibenzyl-3,4,9,10-perylenetetracarboxylic acid diimide N,N′-diphenethyl-3,4,9,10-perylenetetracarboxylic acid diimide; 1,8 chloro quinacridone, 2,9 dichloroquinacridone, quinacridone, and 2,9 dimethyl quinacridone, among others.

In some embodiments, it is preferred that the acidic reagent comprise a first acid at a concentration between about 1 to about 60 wt-%, and preferably between about 20 to about 40 wt-%, and a second acid at a concentration between about 0.2 to about 3 wt-%. When the second acid is provided at low concentrations, for example, below about 5, 3 or 1 wt-%, relative to a higher concentration, for example, above about 10 wt-%, of a first acid, a second acid may also be considered an additive in the context discussed above, wherein the second acid may be selected from, for example, the group consisting of maleic acid, citric acid, malic acid, and acetic acid.

Boron hydride fuels can be converted to hydrogen by regulating the rate or feeding ratio of the acidic reagent solution to the boron hydride, the concentration of the acidic reagent, or both, in order to regulate hydrogen generation rates and profiles, for example, as disclosed in U.S. Patent Application Publication. No. 2005/0238573 A1, “Method for Hydrogen Generation From Solid Chemical Hydride,” the disclosure of which is incorporated herein by reference in its entirety.

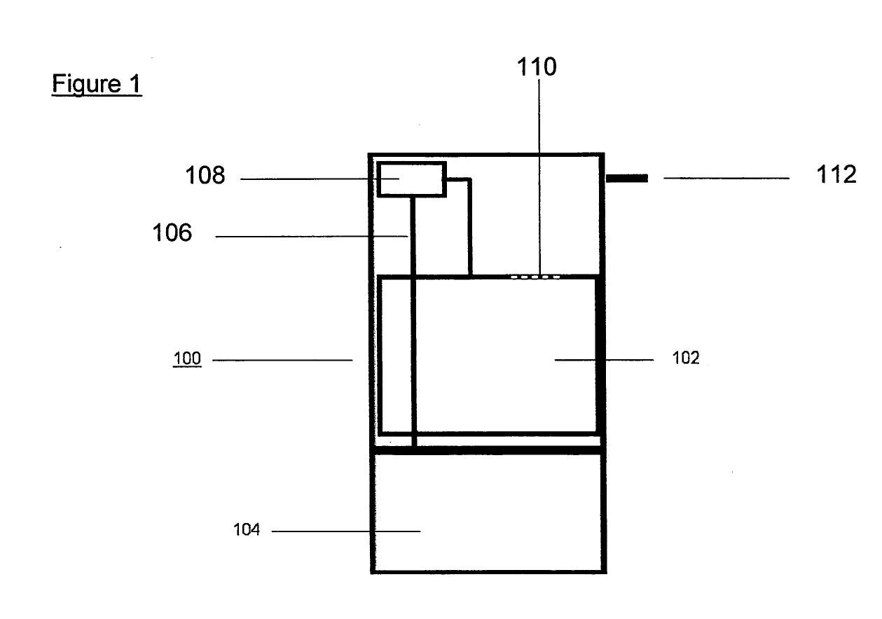

Referring to FIG. 1, an exemplary fuel cartridge 100 suitable for use with the methods and formulations described above comprises a fuel storage region (a first chamber) 102 for storing the boron hydride fuel, an acidic reagent storage region (a second chamber) 104 for storing an acidic reagent, a conduit 106 for conveying the reagent solution from the second region to the first region, and a hydrogen gas outlet 112. It is preferred that at least a portion of the fuel storage region 102 and of the acid storage region 104 be flexible to allow a volume exchanging configuration such that region 104 shrinks while region 102 expands when acidic reagent is consumed. A control element 108 such as a valve or a pump may be employed to regulate the flow of acid from storage region 104 via conduit 106 to the fuel storage region 102.

The first chamber preferably includes at least one hydrogen permeable membrane 110. Suitable gas permeable membranes include materials that are more permeable to hydrogen than water, such as silicon rubber, fluoropolymers, or any hydrogen-permeable metal membrane, such as palladium-gold alloy. Preferably, the hydrogen separation membrane is hydrophobic. This membrane will allow hydrogen gas to pass through, while substantially maintaining solids and liquids within region 102. The hydrogen gas can then accumulate, for example, in the voids of the fuel cartridge until required. Alternatively, the hydrogen gas outlet 112 may be directly connected to the first chamber 102 and may be in communication with or comprise at least one gas permeable membrane capable of allowing hydrogen to pass through the membrane, while preventing solid and liquid materials from passing through the membrane.

In operation, the acidic reagent is fed from the second chamber 104 to the first chamber 102 to contact the boron hydride fuel. The reaction of the acidic reagent and boron hydride fuel generates hydrogen within the first chamber. The produced hydrogen passes through the hydrogen separation membrane 110 that bounds at least a portion of the first chamber 102 before passing through a hydrogen gas outlet 112 for delivery to a fuel cell, for example, for conversion to electricity.

It is preferable to include a multi-channel liquid distributor to disperse the acidic reagent delivered to the first chamber 102 so that the diffusion path for the solution to reach unreacted boron hydride is minimized. The multi-channel liquid distributor comprises a plurality of channels which can be oriented generally parallel to one another or at variable angles to one another, and can deliver the liquid as, for example, a stream or discrete drops. Suitable liquid distribution elements include, but are not limited to, multi-port valves, multi-channel nozzles, and multi-channel sprayers or atomizers.

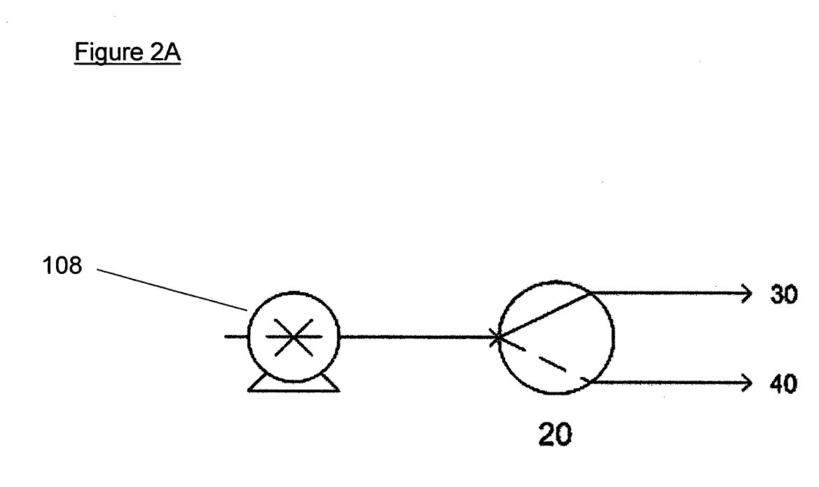

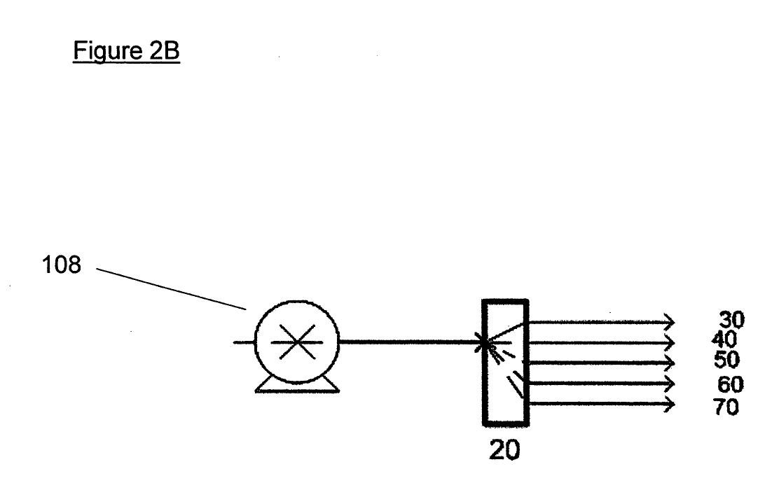

Referring to FIG. 2, a valve 20 comprising a plurality of alternate ports can deliver acid to multiple distribution points with controlled switching frequency in combination with pump 108. A dual port valve is illustrated in FIG. 2A and a 5 point valve is illustrated in FIG. 2B. The pump 108 feeds acid via conduit 106 to the multi-port valve 20 and the acid is delivered to each of the distribution channels 30 and 40 in sequence. A control sequence is chosen to switch from one port (for example, alternate port 30) to another (for example, alternate port 40) at one or more desired frequencies. The acid flow rate to each channel can be determined, for example, by the total acid flow divided by the number of ports. Increases in the switching frequency reduce the pulse of the acid flow in each channel, achieving a more stable flow in each channel. The frequency of valve switching can be controlled using, for example, timers or counters for each channel or other mechanical switching mechanisms.

The following examples further describe and demonstrate features of the systems and methods for hydrogen generation according to the present invention. The examples are given solely for illustration purposes and are not to be construed as limitating the present invention. Various other approaches will be readily ascertainable to one skilled in the art given the teachings herein.

### EXAMPLE 1

System dynamics and H₂ flow rates were measured in a semi-batch reactor system with boron hydride fuels loaded in a 250 mL Pyrex reactor. The acidic reagent was fed through a single point ( 1/16″ o.d. tubing) at a constant feed rate of 10 mL/h. Reaction temperature was monitored with an internal thermal couple. Hydrogen was cooled to room temperature through a water/ice bath and passed through a bed of silica gel to remove any moisture in the gas stream. The dried H₂ flow rate was measured with an on-line mass flow meter. The boron hydride conversion was analyzed using NMR of the post-reaction mixture after each run was completed.

Samples of a sodium borohydride/sodium hydroxide fuel composition (5.75 g consisting of 87 wt-% borohydride and 13 wt-% hydroxide based on the weight of the solid fuel) were reacted with a 27 wt-% sulfuric acid solution containing about 2 wt-% of an additive (based on the weight of the acidic reagent) as shown in Table 1. The use of an additive in the acidic reagent reduced foaming and hydrogen off-gassing due to unreacted reagents as compared to the control sample using sulfuric acid with no additive with acceptable fuel conversion. It was possible to stop and restart the hydrogen generation reaction by regulating the flow of acid, and to substantially consume all fuel.

TABLE 1
Hydrolysis of Sodium Borohydride Fuel Blend with 27 wt-%
H₂SO₄

| | | |
|---|---|---|
| | Reagent | Fuel conversion |
| Additive in 27 wt-% H₂SO₄ | mL | % |

Approximately 25% Conversion

| | | |
|---|---|---|
| None | 3.97 | 24.5 |
| 2 wt-% 2-Methoxyethyl ether | 3.96 | 24 |
| 2 wt-% ethylene glycol | 3.48 | 24 |
| 2 wt-% Tetrahydrofurfyl alcohol | 3.97 | 25 |
| 2 wt-% Ethane 1,2 diamine | 3.93 | 27 |

Approximately 50% Conversion

| | | |
|---|---|---|
| None | 6.29 | 47 |
| 0.25 wt-% pyranthrenedione | 6.89 | 45 |
| 2 wt-% Ethane 1,2 diamine | 6.88 | 49 |
| 2 wt-% Tetrahydrofurfyl alcohol | 6.96 | 50.5 |
| 2 wt-% 2-Methoxyethyl ether | 6.94 | 50 |
| 2 wt-% ethylene glycol | 6.01 | 51 |

Approximately 80% Conversion

| | | |
|---|---|---|
| 2 wt-% 2-Methoxyethyl ether | 9.95 | 79 |
| 2 wt-% Tetrahydrofurfyl alcohol | 10 | 80 |
| 2 wt-% Ethane 1,2 diamine | 9.97 | 82.5 |

Approximately 90% Conversion

| | | |
|---|---|---|
| None | 11 | 89 |
| 0.25 wt-% pyranthrenedione | 11.29 | 89 |
| 2 wt-% Ethane 1,2 diamine | 11.86 | 90 |

Approximately 95% Conversion

| | | |
|---|---|---|
| None | 11.97 | 95 |
| 2 wt-% ethylene glycol | 11.3 | 95 |
| 2 wt-% Tetrahydrofurfyl alcohol | 13.45 | 97 |
| 2 wt-% 2-Methoxyethyl ether | 12.92 | 99 |

### EXAMPLE 2

Samples of a hydrated sodium borohydride/sodium hydroxide fuel composition (consisting of 47.5 wt-% borohydride, 2.5 wt-% hydroxide, and 50 wt-% H₂O based on the weight of the fuel, such that the composition contained 5 g NaBH₄) were reacted with sulfuric acid solutions with concentrations ranging from 27 wt-% to 50 wt-% using the methods described in Example 1.

The use of hydrated fuel formulations reduced hydrogen off-gassing due to unreacted reagents as compared to a nonhydrated standard with acceptable fuel conversion. It is possible to stop and restart the hydrogen generation reaction by regulating the flow of acid, and to substantially consume all fuel as shown in Table 2.

TABLE 2
Hydrolysis of Hydrated Sodium Borohydride Fuel Blend with
H₂SO₄

| | | | H₂ Produced | |
|---|---|---|---|---|
| Acid | | | | Average |
| Conc. | Vol | | | generation rate |
| (wt-%) | (mL) | Conversion % | mL @ NTP | (mL/min) |

Approximately 50% Conversion

| | | | | |
|---|---|---|---|---|
| 27 | 3.35 | 48% | 6044 | 189 |
| 40 | 3.50 | 49% | 7649 | 158 |

Approximately 80% Conversion

| | | | | |
|---|---|---|---|---|
| 30 | 6.00 | 82% | 10388 | 238 |
| 40 | 6.90 | 86% | 10934 | 187 |
| 50 | 6.96 | 82% | 10425 | 149 |

Approximately 90% Conversion

| | | | | |
|---|---|---|---|---|
| 27 | 10.00 | 91% | 11521 | 189 |
| 30 | 9.70 | 93% | 11797 | 188 |
| 40 | 9.97 | 93% | 11747 | 156 |
| 50 | 9.95 | 93% | 11766 | 193 |

### EXAMPLE 3

Samples of a hydrated sodium borohydride/sodium hydroxide fuel composition (consisting of 47.5 wt-% sodium borohydride, 2.5 wt-% sodium hydroxide, and 50 wt-% H₂O based on the weight of the fuel, such that the composition contained 5 g NaBH₄) were reacted with a 27 wt-% sulfuric acid solution containing 2 wt-% ethylene glycol (based on the weight of the acidic reagent) using acid fed via a 3-way valve controlled by a timer for pulse two-point acid feeding to the reactor as shown in FIG. 2A.

The use of hydrated fuel formulations in combination with an additive in the acidic reagent demonstrated high fuel conversion and hydrogen generation flow rates with minimal foaming and unreacted residual acid. It is possible to stop and restart the hydrogen generation reaction by regulating the flow of acid, and to substantially consume all fuel as shown in Table 3.

TABLE 3
Hydrolysis of Hydrated Sodium Borohydride Fuel
Blend with H₂SO₄

| Acid, mL | Conversion % | H2 rate, mL/min |
|---|---|---|
| 3.87 | 55% | 302 |
| 6.97 | 79% | 254 |
| 10.44 | 95% | 206 |
| 11.91 | 96% | 184 |

While the present invention has been described with respect to particular disclosed embodiments, it should be understood that numerous other embodiments are within the scope of the present invention. Accordingly, it is not intended that the present invention be limited to the illustrated embodiments, but only by the appended claims.

What is claimed as new and desired to be protected by Letters Patent of the United States is:

1. A method of generating hydrogen gas, comprising:
providing a boron hydride fuel;
providing an acidic reagent comprising at least one additive; and
contacting the boron hydride fuel with the acidic reagent in the presence of water to generate hydrogen gas and a borate product.

2. The method of claim 1, wherein the acidic reagent is brought into contact with the boron hydride fuel via a multi-channel liquid distributor.

3. The method of claim 2, wherein the liquid distributor comprises a valve having a plurality of acidic reagent ports.

4. The method of claim 3, wherein, the acidic reagent is fed through alternate valve ports in sequence.

5. The method of claim 1, wherein the fuel comprises at least one borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation.

6. The method of claim 1, wherein the fuel comprises at least one salt selected from the group consisting of triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, wherein M is a cation selected from the group consisting of alkali metal cations, alkaline earth metal cations, aluminum cation, zinc cation, and ammonium cation, and n is equal to the charge of the cation.

7. The method of claim 1, wherein the fuel comprises at least one hydrated borohydride composition of formula M(BH₄)ₙ+x H₂O comprising water in amounts from about 50 to about 60 wt-%, wherein M is selected from the group consisting of alkali metal cations, alkaline earth metal cations, aluminum cation, zinc cation, and ammonium cation; n corresponds to the charge of the selected M cation; and x is a number between 1 and 5.

8. The method of claim 7, wherein the fuel is a solution.

9. The method of claim 7, wherein the fuel is a slurry.

10. The method of claim 7, wherein the fuel is a solid.

11. The method of claim 1, wherein the fuel further comprises a stabilizer agent selected from the group consisting of metal hydroxides, anhydrous metal metaborates, hydrated metal metaborates, and mixtures thereof.

12. The method of claim 1, wherein the acidic reagent comprises an aqueous solution of at least one acid in a concentration of about 1 to about 60 wt-% and an additive in a concentration of about 0.1 to about 10 wt-%.

13. The method of claim 1, wherein the additive is present in a concentration of about 0.2 to about 3 wt-% of the solution.

14. The method of claim 1, wherein the acid is present in a concentration of about 20 to about 40 wt-% of the solution.

15. The method of claim 1, wherein the acidic reagent comprises a material selected from the group consisting of hydrochloric acid (HCl), sulfuric acid (H₂SO₄), phosphoric acid (H₃PO₄), acetic acid (CH₃COOH), formic acid (HCOOH), maleic acid, malic acid, citric acid, and tartaric acid.

16. The method of claim 1, wherein the additive comprises a material selected from the group consisting of ethers of diols, amines, amino alcohols, amides, and fused ring heteroaromatics.

17. The method of claim 1, wherein the additive comprises a material selected from the group consisting of 1,2-dimethoxyethane (glyme), diethylene glycol dimethyl ether (diglyme), triethylene glycol dimethyl ether (triglyme), tetraethylene glycol dimethyl ether (tetraglyme), dimethylacetamide, and ethylene diamine.

18. The method of claim 1, wherein the additive comprises a material selected from the group consisting of pyranthrenedione, indanthrene pigments, violanthrone pigments, 3,4,9,10-perylenetetracarboxylic diimide pigments, quinacridone pigments, 1,4-diketopyrrolo[3,4-c]pyrrole pigments, copper phthalocyanine, and indigo dye.

19. The method of claim 1, wherein the acid is sulfuric acid and the additive is ethylene diamine.

20. The method of claim 1, wherein the acid is sulfuric acid and the additive is 2-methoxyethyl ether (diglyme).

21. The method of claim 1, wherein the acid is sulfuric acid and the additive is pyranthrenedione.

22. The method of claim 1, wherein the additive comprises a carboxylic acid in a concentration of about 0.2 to about 3 wt-% of the solution.

23. The method of claim 22, wherein the carboxylic acid is selected from the group consisting of maleic acid, citric acid, malic acid, and acetic acid.

24. The method of claim 1, wherein the acid is sulfuric acid and the additive is maleic acid.

25. A method of generating hydrogen gas, comprising:
providing a boron hydride fuel;
providing an acidic reagent comprising at least one alcohol; and
contacting the boron hydride fuel with the acidic reagent in the presence of water to generate hydrogen gas and a borate product,
wherein the acidic reagent is brought into contact with the boron hydride at more than one distribution point via a multi-channel distributor comprising a plurality of acidic reagent ports.

26. The method of claim 25, wherein the acidic reagent is fed through alternate ports of said plurality of ports in sequence.

27. The method of claim 25, wherein the fuel comprises at least one borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation.

28. The method of claim 25, wherein the fuel comprises at least one salt selected from the group consisting of triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, wherein M is a cation selected from the group consisting of alkali metal cations, alkaline earth metal cations, aluminum cation, zinc cation, and ammonium cation, and n is equal to the charge of the cation.

29. The method of claim 25, wherein the fuel comprises at least one hydrated borohydride composition represented by formula M(BH₄)ₙ+x H₂O comprising water in amounts from about 50 to about 60 wt-%, wherein M is selected from the group consisting of alkali metal cations, alkaline earth metal cations, aluminum cation, zinc cation, and ammonium cation; n corresponds to the charge of the selected M cation; and x is a number between 1 and 5.

30. The method of claim 25, wherein the fuel is a solution.

31. The method of claim 25, wherein the fuel is a slurry.

32. The method of claim 25, wherein the fuel is a solid.

33. The method of claim 25, wherein the fuel further comprises a stabilizer agent selected from the group consisting of metal hydroxides, anhydrous metal metaborates, hydrated metal metaborates, and mixtures thereof.

34. The method of claim 25, wherein the acidic reagent comprises an aqueous solution of at least one acid in a concentration of about 1 to about 60 wt-% and an alcohol in a concentration from about 0.1 to about 10 wt-%.

35. The method of claim 34, wherein the alcohol is present in a concentration of about 0.2 to about 3 wt-% of the solution.

36. The method of claim 34, wherein the acid is present in a concentration of about 20 to about 40 wt-% of the solution.

37. The method of claim 25, wherein the reagent comprises a material selected from the group consisting of hydrochloric acid, sulfuric acid, phosphoric acid, acetic acid, formic acid, maleic acid, malic acid, citric acid, and tartaric acid.

38. The reagent of claim 25, wherein the additive comprises a material selected from the group consisting of methanol, ethanol, ethylene glycol, propylene glycol, tetrahydrofuryl alcohol, and 2-aminoethanol.

39. The method of claim 25, wherein the acid is sulfuric acid and the additive is tetrahydrofuryl alcohol.

40. The method of claim 25, wherein the acid is sulfuric acid and the additive is ethylene glycol.

41. A hydrogen gas generation system, comprising:
a first region for containing a boron hydride fuel;
a second region for containing a reagent solution having a pH of less than about 7;
at least one gas permeable membrane in contact with the first region, wherein the membrane is configured to allow hydrogen to pass through the membrane while preventing solid and liquid materials from passing through the membrane;
a multi-channel liquid distributor comprising a plurality of ports configured to feed the reagent solution into said first region through alternate ports of said plurality of ports; and
a control mechanism for regulating the flow of reagent solution from the second region to the first region through said alternate ports in a predetermined sequence.

42. The system of claim 41, wherein said multi-channel distributor comprises a multi-port valve.

43. The system of claim 41, wherein said multi-channel distributor comprises a multi-channel nozzle.

44. The system of claim 41, wherein said multi-channel distributor comprises a multi-port sprayer or atomizer.

45. The system of claim 41, wherein said control mechanism is configured to minimize diffusion paths of the reagent through reacted fuel to reach unreacted fuel.

46. The system of claim 41, wherein said control mechanism comprises a timer.

47. The hydrogen gas generation system of claim 41, wherein at least one of the first and second regions is bounded by a movable partition to provide a volume exchanging configuration.

48. The hydrogen gas generation system of claim 41, wherein at least one of the first and second regions is bounded by a flexible material to provide a volume exchanging configuration.
